(19) United States
(12) Patent Application Publication
(10) Pub. No.: US 2026/0184336 A1
(43) Pub. Date: Jul. 2, 2026

(54) METHOD FOR CONTROLLING AUTONOMOUS DRIVING AND APPARATUS THEREOF

(71) Applicant: HYUNDAI AUTOEVER CORP., Seoul (KR)

(72) Inventor: Lam LEE, Seoul (KR)

(21) Appl. No.: 19/338,297

(22) Filed: Sep. 24, 2025

(30) Foreign Application Priority Data
Dec. 30, 2024 (KR) 10-2024-0200803

(51) Int. Cl. B60W 60/00; G06N 20/00

(52) U.S. Cl. CPC B60W 60/001; G06N 20/00

(57) ABSTRACT

Methods and apparatus for controlling autonomous driving of a vehicle are described. According one embodiment, the method comprises acquiring data on driving-related manipulation of a first mobility during a manipulation collection period determined by an adjacent state maintenance period between the first mobility and a second mobility which are in manual driving and training an autonomous driving artificial intelligence model by using the data, wherein the autonomous driving artificial intelligence model outputs a route of the first mobility when the first mobility which is in autonomous driving senses a third mobility adjacent thereto.

### CROSS-REFERENCE TO RELATED APPLICATION

This application claims priority from Korean Patent Application No. 10-2024-0200803 filed on Dec. 30, 2024 in the Korean Intellectual Property Office and all the benefits accruing therefrom under 35 U.S.C. 119, the contents of which in its entirety are herein incorporated by reference.

### BACKGROUND

### Technical Field

The present disclosure relates to a method for controlling autonomous driving of a mobility including a vehicle and an apparatus thereof, and more particularly, to a method for learning an artificial intelligence model for autonomous driving and controlling driving of a vehicle by using the learned artificial intelligence model and an apparatus thereof.

### Description of the Related Art

Autonomous driving refers to a technology in which a mobility (e.g., a vehicle, an aircraft, and a ship) drives by recognizing and judging the environment by themselves without human intervention. Data related to driving may be collected through devices such as sensors, cameras, and radars, and an artificial intelligence algorithm may determine a driving route by analyzing the collected data.

The conventional autonomous driving technology complies with standardized driving styles, making it difficult to consider individual driving habits and preferences. For example, drivers who prefer aggressive lane changes or fast driving may find overly cautious driving frustrating. This type of autonomous driving may lead to driver dissatisfaction and psychological stress.

Therefore, to reduce psychological stress of the driver and gain the driver's trust, an autonomous driving system capable of learning and reflecting more personalized driving patterns is needed.

### SUMMARY

An object of the present disclosure is to provide a method for controlling autonomous driving to provide a stable and satisfactory driving experience to a driver, and an apparatus thereof.

Another object of the present disclosure is to provide a method for controlling autonomous driving by quantifying a driver's stress and utilizing the quantified numerical value, and an apparatus thereof.

Other object of the present disclosure is to provide a method for controlling autonomous driving of a vehicle like a driver's direct driving, and an apparatus thereof.

The objects of the present disclosure are not limited to those mentioned above and additional objects of the present disclosure, which are not mentioned herein, will be clearly understood by those skilled in the art from the following description of the present disclosure.

According to an aspect of the present disclosure, there is provided a method for controlling autonomous driving. The method may comprise acquiring data on driving-related manipulation of the first mobility during a manipulation collection period determined by an adjacent state maintenance period between the first mobility and a second mobility which are in manual driving; and learning an autonomous driving artificial intelligence model by using the acquired data, wherein the autonomous driving artificial intelligence model may be an artificial intelligence model that outputs a route of the first mobility when the first mobility which is in autonomous driving senses a third mobility adjacent thereto.

In some embodiments, the autonomous driving artificial intelligence model may be an artificial intelligence model that additionally outputs a manipulation value of a driving-related device of the first mobility to drive on the route when the first mobility which is in autonomous driving senses the adjacent third mobility.

In some embodiments, the acquiring data on driving-related manipulation of the first mobility may include: additionally acquiring data on a driving environment of the first mobility during the manipulation collection period; learning the autonomous driving artificial intelligence model by using the acquired data; and learning the autonomous driving artificial intelligence model by using the data on driving-related manipulation of the first mobility and the data on the driving environment of the first mobility.

In some embodiments, the acquiring data on driving-related manipulation of the first mobility may include additionally acquiring data on a passenger of the first mobility during the manipulation collection period, and the learning the autonomous driving artificial intelligence model by using the acquired data may include learning the autonomous driving artificial intelligence model by using the data on driving-related manipulation of the first mobility and the data on a passenger of the first mobility.

In some embodiments, the data on a passenger may include at least one of data on a type of the passenger of the first mobility, a location of the passenger of the first mobility or a combination of the passenger of the first mobility.

In some embodiments, the acquiring data on driving-related manipulation of the first mobility may include: additionally acquiring data on a type of the second mobility during the manipulation collection period; learning the autonomous driving artificial intelligence model by using the acquired data; and learning the autonomous driving artificial intelligence model by using the data on driving-related manipulation of the first mobility and the data on a type of the second mobility.

In some embodiments, the acquiring data on driving-related manipulation of the first mobility may include additionally acquiring data on a relative location change of the second mobility during the manipulation collection period, and the learning the autonomous driving artificial intelligence model by using the acquired data may include learning the autonomous driving artificial intelligence model by using the data on driving-related manipulation of the first mobility and the data on a relative location change of the second mobility.

In some embodiments, the acquiring data on driving-related manipulation of the first mobility may include additionally acquiring data on a driver's voice of the first mobility during the manipulation collection period, and the learning the autonomous driving artificial intelligence model by using the acquired data may include learning the autonomous driving artificial intelligence model by using the data on driving-related manipulation of the first mobility and the data on a driver's voice of the first mobility.

In some embodiments, the data on a driver's voice may include at least one data of a size of the driver's voice, a pitch of the driver's voice, or a keyword included in the driver's voice.

In some embodiments, the learning an autonomous driving artificial intelligence model by using the acquired data further may include filtering the acquired data based on whether a traffic accident has occurred during the manipulation collection period.

In some embodiments, after learning an autonomous driving artificial intelligence model, the method may further comprise: sensing the third mobility adjacent to the first mobility during autonomous driving of the first mobility; and controlling autonomous driving of the first mobility so that the first mobility drives on the route output by the learned autonomous driving artificial intelligence model.

In some embodiments, the controlling autonomous driving of the first mobility may include: receiving data on a route of the third mobility from the third mobility; adjusting the route of the first mobility in consideration of the received route of the third mobility; and controlling autonomous driving of the first mobility so that the first mobility drives on the adjusted route.

In some embodiments, the third mobility may be a same kind of mobility as the second mobility.

In some embodiments, after the learning an autonomous driving artificial intelligence model, The method may further comprise: applying the learned autonomous driving artificial intelligence model to a fourth mobility; sensing the third mobility adjacent to the fourth mobility during autonomous driving of the fourth mobility; and controlling autonomous driving of the fourth mobility so that the fourth mobility drives on the route output by the learned autonomous driving artificial intelligence model, wherein the fourth mobility may be a mobility different from the first mobility.

In some embodiments, the fourth mobility may be a mobility occupied by a driver of the first mobility.

According to the aforementioned other embodiments of the present disclosure, there is provided an apparatus for controlling autonomous driving. The apparatus may comprise a communication interface; a memory in which a computer program is loaded; and one or more processors in which the computer program is executed, wherein the computer program may include instructions to perform: an operation of acquiring data on driving-related manipulation of a first mobility during a manipulation collection period determined using an adjacent state maintenance period between the first mobility and a second mobility, which are in manual driving; and an operation of learning an autonomous driving artificial intelligence model by using the acquired data, wherein the autonomous driving artificial intelligence model is an artificial intelligence model that outputs a route of the first mobility when the first mobility which is in autonomous driving senses a third mobility adjacent thereto.

In some embodiments, the autonomous driving artificial intelligence model is an artificial intelligence model that additionally outputs a manipulation value of a driving-related device of the first mobility to drive on the route when the first mobility which is in autonomous driving senses the adjacent third mobility.

In some embodiments, the computer program, after the operation of learning an autonomous driving artificial intelligence model, may further include instructions to perform: an operation of sensing the third mobility adjacent to the first mobility during autonomous driving of the first mobility; and an operation of controlling autonomous driving of the first mobility so that the first mobility drives on the route output by the learned autonomous driving artificial intelligence model.

In some embodiments, the operation of controlling autonomous driving of the first mobility may include: an operation of receiving data on a route of the third mobility from the third mobility; an operation of adjusting the route of the first mobility in consideration of the received route of the third mobility; and an operation of controlling autonomous driving of the first mobility so that the first mobility drives on the adjusted route.

In some embodiments, the computer program, after the operation of learning an autonomous driving artificial intelligence model, may further include: an operation of applying the learned autonomous driving artificial intelligence model to a fourth mobility; an operation of sensing the third mobility adjacent to the fourth mobility during autonomous driving of the fourth mobility; and an operation of controlling autonomous driving of the fourth mobility so that the fourth mobility drives on the route output by the learned autonomous driving artificial intelligence model, wherein the fourth mobility may be a mobility different from the first mobility.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic view illustrating the overall configuration of an apparatus for controlling autonomous driving according to one embodiment of the present disclosure;

FIG. 2 is a flow chart illustrating a method for controlling autonomous driving according to another embodiment of the present disclosure;

FIGS. 3 to 6 are detailed exemplary views illustrating the method described with reference to FIG. 2;

FIG. 7 is a detailed flow chart illustrating some operations of the method described with reference to FIG. 2;

FIG. 8 is a detailed exemplary view illustrating the method described with reference to FIG. 7;

FIG. 9 is another detailed flow chart illustrating some operations of the method described with reference to FIG. 2;

FIGS. 10 and 11 are detailed exemplary views illustrating the method described with reference to FIG. 9;

FIG. 12 is another detailed flow chart illustrating some operation of the method described with reference to FIG. 2;

FIG. 13 is an exemplary view illustrating the method described with reference to FIG. 12;

FIG. 14 is still another detailed flow chart illustrating some operations of the method described with reference to FIG. 2;

FIGS. 15 and 16 are exemplary views illustrating the method described with reference to FIG. 14;

FIG. 17 is still another detailed flow chart illustrating some operations of the method described with reference to FIG. 2;

FIG. 18 is a detailed exemplary view illustrating the method described with reference to FIG. 17;

FIG. 19 is still another detailed flow chart illustrating some operations of the method described with reference to FIG. 2;

FIGS. 20 and 21 are detailed exemplary views illustrating the method described with reference to FIG. 19;

FIG. 22 is still another detailed flow chart illustrating some operations of the method described with reference to FIG. 2;

FIGS. 23 and 24 are detailed exemplary views illustrating the method described with reference to FIG. 22;

FIG. 25 is still another detailed flow chart illustrating some operations of the method described with reference to FIG. 2;

FIG. 26 is a detailed exemplary view illustrating the method described with reference to FIG. 25;

FIG. 27 is still another detailed flow chart illustrating some operations of the method described with reference to FIG. 2;

FIG. 28 is an exemplary view illustrating the method described with reference to FIG. 27;

FIG. 29 is still another detailed flow chart illustrating some operations of the method described with reference to FIG. 2;

FIGS. 30 and 31 are detailed exemplary views illustrating the method described with reference to FIG. 29; and

FIG. 32 is a block diagram illustrating a hardware configuration of a computing device used in some embodiments of the present disclosure.

### DETAILED DESCRIPTION OF THE DISCLOSURE

First, before describing embodiments of the present disclosure, a target to which the present disclosure is applied will be described. Some embodiments of the present disclosure may be applied to mobility. The mobility may refer to a moving means by which a person may control driving. For example, the mobility may include a vehicle, a train, an aircraft, a ship, a personal moving device, and an unmanned aerial vehicle. Hereinafter, for convenience of description, some embodiments of a vehicle among the mobility will be described. However, it should be noted that some embodiments of the present disclosure are not limited to the vehicle, and may also be applied to other mobility described above.

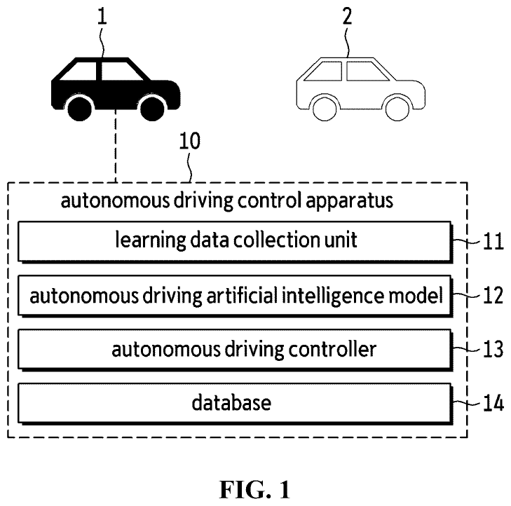

A configuration and operation of an apparatus for controlling autonomous driving according to one embodiment of the present disclosure will be described with reference to FIG. 1.

An apparatus 10 for controlling autonomous driving of the present disclosure may mean an apparatus that controls autonomous driving of a vehicle 1 when another vehicle 2 is located within a preset distance from the vehicle 1. The autonomous driving control apparatus 10 may collect data for learning during a driving process of the vehicle 1, learn an artificial intelligence model by using the collected data and control autonomous driving of the vehicle 1 by using the learned artificial intelligence model.

The autonomous driving control apparatus 10 of the present disclosure may be a computing device present in the vehicle 1. In addition, the autonomous driving control apparatus of the present disclosure may be configured as a plurality of computing devices. One of the plurality of computing devices may be a computing device located in the vehicle 1. In addition, one of the plurality of computing devices may be a computing device (e.g., server) located in a space away from the vehicle 1.

The autonomous driving control apparatus 10 of the present disclosure may include at least one of a learning data collection unit 11, an autonomous driving artificial intelligence model 12, an autonomous driving controller 13, and a database 14. Hereinafter, an autonomous driving control apparatus according to an adjacent vehicle will be abbreviated as an autonomous driving control apparatus.

The learning data collection unit 11 may collect data related to autonomous driving learning of a vehicle (hereinafter, referred to as the present vehicle), which is an autonomous control target of the autonomous driving control apparatus according to the present embodiment. In detail, the data collection unit 11 may collect data related to driving of a driver during a manipulation collection period (hereinafter, referred to as a manipulation collection period) determined by a period at which the present vehicle and another vehicle maintain an adjacent state.

The manipulation collection period may mean a period from a time before a preset time at the time when the present vehicle senses another vehicle, to a time after a preset time after a distance between the present vehicle and another vehicle exceeds a preset distance. For example, the manipulation collection period may be a period from a time period of 5 seconds before the present vehicle senses another vehicle to a time period from 5 seconds after the distance between the present vehicle and another vehicle becomes 500 m.

When a vehicle (hereinafter, referred to as an adjacent vehicle) is located within a preset distance from the present vehicle, the learning data collection unit 11 may collect data related to a detailed vehicle model of the adjacent vehicle, a type of the adjacent vehicle (e.g., a two-wheeled vehicle, a passenger car, a van, a truck, a special vehicle), a speed of the adjacent vehicle, and movement of the adjacent vehicle.

In addition, when the adjacent vehicle is located within a preset distance from the present vehicle, the learning data collection unit 11 may collect data related to a speed of the present vehicle, a driving pattern (e.g., acceleration, deceleration, overtaking, lane change), the number and type of passengers of the present vehicle (e.g., adults, children, infants, and the elderly), and information on the driver of the present vehicle (e.g., driver's voice, driver's view limitation level, and driver's stress level).

In addition, when the adjacent vehicle is located within a preset distance from the present vehicle, the learning data collection unit 11 may collect data related to a state of a road surface (e.g., good, neutral, and bad), traffic congestion level (e.g., smooth, neutral, and congested), a type of road (e.g., highway, national road, suburban road, urban road, and unpaved road), traffic facility (e.g., traffic light, crosswalk, and traffic sign) located nearby, weather (e.g., sunny, cloudy, rain, snow, and fog) of the corresponding time point, and time (e.g., dawn, morning, afternoon, evening, and night) of the corresponding time point. The traffic congestion level may mean the degree to which the traffic flow is delayed due to the number of vehicles exceeding the capacity of the road in a specific road section or at a specific time zone.

That is, the learning data collection unit 11 may perform all operations for collecting data for learning the artificial intelligence model of the autonomous driving control apparatus according to some embodiments of the present disclosure.

The autonomous driving artificial intelligence model 12 may learn a driver's driving pattern by using the data collected by the learning data collection unit 11. The driving pattern may include a route of the present vehicle and manipulation values of driving-related devices (e.g., excel, brake, gear, and handle) for driving on the route when the present vehicle on which the driver travels encounters a specific type of adjacent vehicle.

For example, the driver of the present vehicle may avoid the adjacent vehicle that restricts a view of the driver. A method of avoiding the adjacent vehicle may vary depending on the driver. A first driver may change only a lane to avoid the adjacent vehicle, a second driver may increase a vehicle-to-vehicle distance to avoid the adjacent vehicle, and a third driver may avoid the adjacent vehicle after changing a lane. As in the above example, the movement of the present vehicle, which varies depending on the driver and the adjacent vehicle, may be referred to as the driving pattern of the vehicle.

The driving pattern may be divided into types such as an increase in a vehicle-to-vehicle distance, lane change, and overtaking. Also, even in the same type, detailed values related to the driving pattern may be different. For example, for one driving pattern of the increase in the vehicle-to-vehicle distance, the vehicle-to-vehicle distance may be increased to 30 m. Also, for another driving pattern of the increase in the vehicle-to-vehicle distance, the vehicle-to-vehicle distance may be increased to 50 m. That is, even for the same type of increase in the vehicle-to-vehicle distance, the detailed value of the vehicle-to-vehicle distance may vary depending on the driving pattern.

Therefore, when the vehicle is located within a preset distance from the present vehicle, the autonomous driving artificial intelligence model 12 may learn the driving pattern of the present vehicle. In addition, when the vehicle is located within a preset distance from the present vehicle after learning, the learned autonomous driving artificial intelligence model 12 may output the driving pattern of the present vehicle in accordance with the learned driving pattern. The output driving pattern means a personalized driving pattern that varies depending on the driver, not a standardized driving pattern, unlike the related art. That is, through the learning process, the autonomous driving artificial intelligence model 12 may output the driving pattern by simulating the driver.

In detail, the autonomous driving artificial intelligence model 12 may receive data related to the present vehicle (e.g., speed, passenger, driver, and amount of fuel), data related to adjacent vehicle (e.g., adjacent vehicle type, adjacent vehicle movement, and adjacent vehicle speed), and data related to the road environment (e.g., time at the time of driving, weather condition at the time of driving, road condition at the time of driving, type of road at the time of driving, and traffic congestion at the time of driving). The autonomous driving artificial intelligence model 12 may output the driving pattern of the present vehicle by using the received data.

The autonomous driving controller 13 may control autonomous driving of the present vehicle by using the driving pattern output by the autonomous driving artificial intelligence model 12.

For example, the autonomous driving controller 13 may change the speed of the present vehicle, change lanes, overtake the adjacent vehicle or adjust a distance from the adjacent vehicle to drive on the route output by the autonomous driving artificial intelligence model 12.

The database 14 may temporarily store data collected by the learning data collection unit 11 of the present disclosure. The temporarily stored data may be used to learn an autonomous driving artificial intelligence model embedded in the vehicle. In addition, to learn the autonomous driving artificial intelligence model present in a separate server from the vehicle, the temporarily stored data may be transmitted to the server. In addition, the database 14 may store data necessary for the operation of all components of the present disclosure. In the following description, the source from which the data is acquired may be omitted, and in this case, it may be understood that the corresponding data is acquired from the database.

It should be noted that the operation of each component of the autonomous driving control apparatus is not limited to the above-described example, and may include an operation related to a method for controlling autonomous driving (hereinafter, referred to as an autonomous driving control method) according to an adjacent vehicle according to some embodiments of the present disclosure, which will be described below. In addition, the technical spirits that may be grasped through some embodiments of the present disclosure described below may be applied to the autonomous driving control apparatus described above even though there is no separate description.

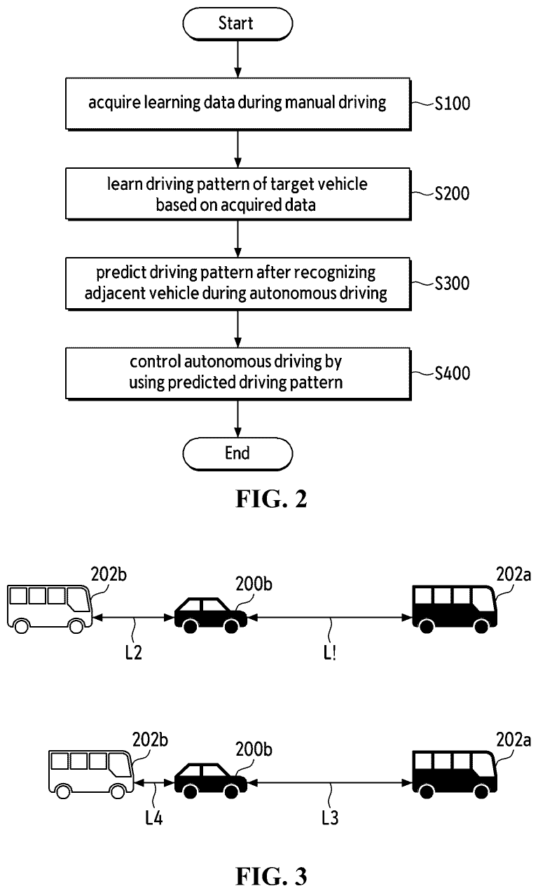

The components of the autonomous driving control apparatus according to an adjacent vehicle according to one embodiment of the present disclosure have been described with reference to FIG. 1. Hereinafter, an autonomous driving control method according to some embodiments of the present disclosure will be described with reference to FIGS. 2 to 39. In the following description, the subject of a specific step/operation may be omitted, and in this case, it may be understood that the step/operation is performed by the computing device constituting the above-described autonomous driving control apparatus. The computing device may be a plurality of computing devices.

First, the autonomous driving control method according to one embodiment of the present disclosure will be described with reference to FIGS. 2 to 6.

As shown in FIG. 2, when another vehicle (hereinafter, referred to as an adjacent vehicle) is located within a preset distance from the present vehicle during manual driving of the present vehicle, data for learning the driving pattern of the present vehicle may be acquired during the manipulation collection period (S100).

The data for learning the driving pattern of the present vehicle may include data (e.g., handling, brake, acceleration, and steering) on driving-related manipulation of the present vehicle, data (e.g., speed, driving time, and amount of fuel) on the condition of the present vehicle, data (e.g., number of passengers, type of passengers, and combination of passengers) related to passengers of the present vehicle, data (e.g., passenger car, van, truck, special vehicle, and two-wheeled vehicle) related to the type of the adjacent vehicle, data (e.g., size of the adjacent vehicle, degree to which the adjacent vehicle limits the driver's field of view, number of lane changes of the adjacent vehicle, and speed of the adjacent vehicle) related to the condition of adjacent vehicle, and data (e.g., time at the time of driving, weather condition at the time of driving, road condition at the time of driving, road type at the time of driving, and traffic congestion at the time of driving) related to the road environment.

The preset distance may mean a distance set in consideration of a distance by which the driver of the present vehicle may sense the adjacent vehicle. For example, as shown in FIG. 3, a preset distance L1 for an adjacent vehicle 202a located at the front may be longer than a preset distance L2 for an adjacent vehicle 202b located at the rear. Since the driver of the present vehicle is more likely to sense the vehicle located at the front, the preset distance may vary depending on the direction.

In addition, the preset distance may mean a distance set in consideration of a distance by which data related to the adjacent vehicle may be collected. For example, as shown in FIG. 3, preset distances L3 and L4 of a present vehicle 200b with better performance of a camera module mounted on the vehicle may be shorter than preset distances L1 and L2 of a general present vehicle 200a. This is because the camera module with better performance may collect data related to the adjacent vehicle even at a longer distance.

The learning data acquired during manual driving may be transmitted to the server. The autonomous driving artificial intelligence model may be learned using the learning data transmitted to the server.

Referring back to FIG. 2, the driving pattern of the present vehicle may be learned by the autonomous driving artificial intelligence model by using the acquired data (S200). In detail, the autonomous driving artificial intelligence model may learn data on driving-related manipulation for driving on the route of the present vehicle and on the corresponding route by using the acquired data when the vehicle is located within a preset distance from the present vehicle. In this case, the data on driving-related manipulation may include detailed manipulation values (e.g., step level of excel, step time of excel, step level of brake, step time of brake, stage of gear, whether or not to change gear, angle of steering wheel, and change in angle of the steering wheel) of the driving-related manipulation device (e.g., excel, brake, gear, and handle).

The driving pattern of the present vehicle may vary depending on the type and relative location of the adjacent vehicle. In addition, the driving pattern of the present vehicle may vary depending on the passenger of the present vehicle. In addition, the driving pattern of the present vehicle may vary depending on the driving environment of the present vehicle.

Next, a vehicle located within a preset distance from the present vehicle may be sensed during autonomous driving. Subsequently, the driving pattern of the present vehicle may be output by the autonomous driving artificial intelligence model (S300). Autonomous driving of the present vehicle may be controlled using the output driving pattern (S400). The driving pattern may mean a detailed manipulation value of the driving manipulation-related drive for driving on the route of the present vehicle and the corresponding route, which vary depending on the driver and the adjacent vehicle.

The autonomous driving artificial intelligence model may infer a type of the adjacent vehicle sensed during autonomous driving and output a driving pattern differently depending on the adjacent vehicle. Also, a range of the adjacent vehicle in which a driving pattern is output differently may vary depending on the driver.

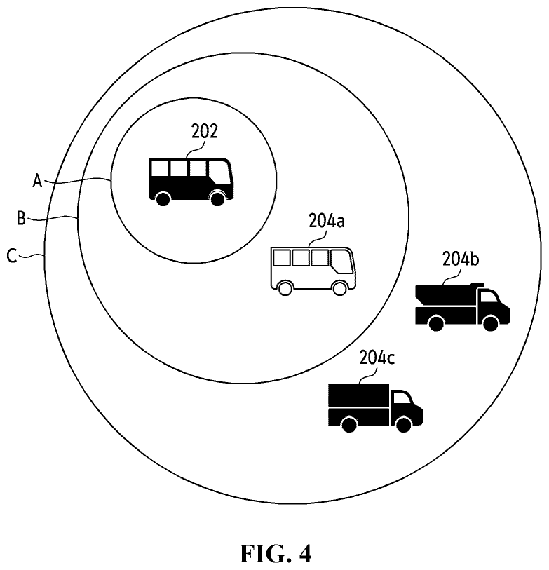

For example, as shown in FIG. 4, the driver may show a specific driving pattern (e.g., overtaking) only with respect to the case A in which a detailed model of vehicle (e.g., a specific model of bus) is the same. Therefore, even in case of the same type of vehicle, when the detailed model of vehicle is different, the driver may not show a specific driving pattern.

As another example, as shown in FIG. 4, the driver may show a specific driving pattern only with respect to the case B in which the type of vehicle (e.g., all types of buses) is the same. Therefore, when the type of vehicle is the same even though the detailed model of vehicle is different, the driver may show a specific driving pattern.

As other example, as shown in FIG. 4, the driver may show a specific driving pattern only with respect to the case C in which a specific condition (e.g., a large car that limits the field of view) is satisfied, regardless of the detailed model of vehicle and the type of vehicle.

As a detailed example, a first driver may overtake only a bus 202 of a first vehicle model and cannot overtake a bus 204a of a second vehicle model. On the other hand, a second driver may overtake all types of buses 202 and 204a regardless of vehicle models. Further, a third driver may overtake all vehicles that are large enough to limit the field of view, including the buses 202 and 204a and trucks 204b and 204c.

As another detailed example, the first driver may show a pattern of changing a lane when sensing a motorcycle that urgently changes a direction from left to right. The second driver may show a pattern of changing a lane when sensing the motorcycle even though the motorcycle does not urgently change a direction from left to right. The third driver may show a pattern of changing a lane when sensing a personal moving device or a bicycle in addition to the motorcycle.

That is, a range of an adjacent vehicle showing a special driving pattern may vary depending on the driver. Accordingly, the autonomous driving artificial intelligence model of the present disclosure may learn the range of the adjacent vehicle in which a driver shows a specific driving pattern, by using the acquired learning data. In addition, the autonomous driving artificial intelligence model of the present disclosure may output a specific driving pattern by varying the range of the adjacent vehicle, which shows a specific driving pattern, depending on the driver.

The above-described specific driving pattern may mean a driving pattern that is output by the autonomous driving artificial intelligence model differently depending on the driver. The specific driving pattern may be different from the standardized driving pattern output by the autonomous driving artificial intelligence model regardless of the driver.

In summary, when the driver of the present vehicle shows a specific driving pattern (e.g., overtaking, lane change) with respect to a specific adjacent vehicle (e.g., bus, truck), the driving pattern may be learned. After learning the driving pattern, when the present vehicle encounters the same type of vehicle as the adjacent vehicle during autonomous driving of the present vehicle, the autonomous driving may be controlled as in the learned driving pattern. Hereinafter, this will be described in detail with examples.

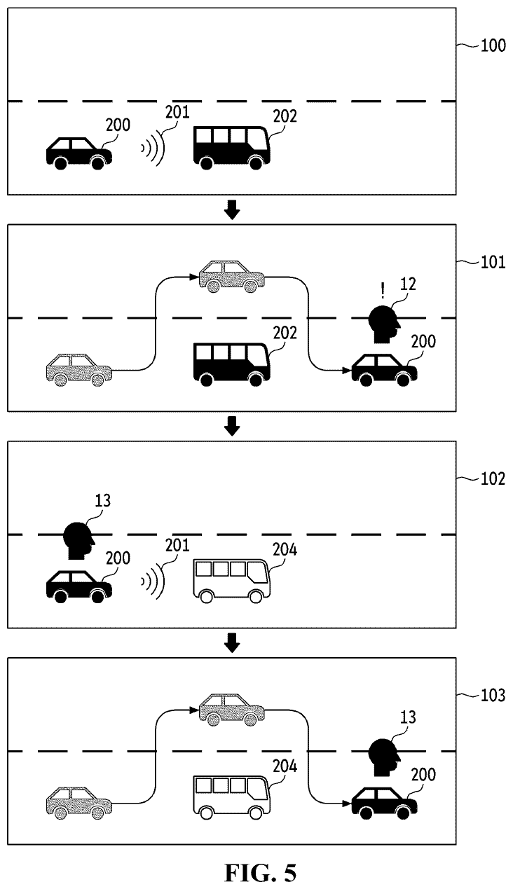

As in the example 100 shown in FIG. 5, the present vehicle 200 may sense (201) the adjacent vehicle 202. In this case, the fact that the present vehicle 200 senses (201) the adjacent vehicle 202 may mean that the adjacent vehicle is sensed using a sensor such as a camera, a radar, and a lidar and vehicle-to-vehicle communication (V2V), and information (e.g., type of the adjacent vehicle, and movement of the adjacent vehicle) is sensed.

Next, as in the example 101 shown in FIG. 5, the present vehicle 200 may overtake the adjacent vehicle 202. In this case, data (e.g., vehicle-to-vehicle distance before overtaking, overtaking speed, vehicle-to-vehicle distance after overtaking, and overtaking time) on driving-related manipulation of the present vehicle and data (e.g., model of the adjacent vehicle, type of the adjacent vehicle, speed of the adjacent vehicle, and movement of the adjacent vehicle) related to the adjacent vehicle may be acquired. Subsequently, the autonomous driving artificial intelligence model may learn about a driving pattern when the present vehicle encounters the adjacent vehicle, by using the acquired data.

The present vehicle of the present disclosure may perform driving multiple times in the same situation as the above-described examples 100 and 101. In addition, the present vehicle may acquire a plurality of learning data in a plurality of driving processes. The driving pattern may be learned for the autonomous driving artificial intelligence model through the data on driving-related manipulation of the vehicle among the plurality of learning data. In addition, a condition in which the driving pattern is performed may be learned for the autonomous driving artificial intelligence model through the data on the adjacent vehicle among the plurality of learning data. That is, the operation S100 of acquiring learning data during manual driving and the operation S200 of learning a driving pattern of the present vehicle using by the acquired data may be repeated multiple times.

Subsequently, as in the example 102 shown in FIG. 5, the present vehicle 200 which is in autonomous driving may sense (201) the same type of vehicle 204 as the adjacent vehicle. The learned autonomous driving artificial intelligence model 13 may output the driving pattern of the present vehicle 200. In detail, the learned autonomous driving artificial intelligence model 13 may infer and determine whether the vehicle 204 currently encountered belongs to a vehicle in which the driver shows a specific driving pattern. In addition, the learned autonomous driving artificial intelligence model 12 may infer and determine whether the driver satisfies additional conditions showing a specific driving pattern.

The additional conditions may be conditions related to whether the current road environment is similar to the road environment (e.g., road surface condition, traffic congestion, weather condition, and type of road) when the present vehicle encounters the adjacent vehicle during learning of the autonomous driving artificial intelligence model 12, whether the current state of the present vehicle is similar to the state of the present vehicle (e.g., the type and number of drivers and passengers, the volume and weight of baggage, the amount of fuel, and the vehicle functional failure state) during learning, and whether the state of the adjacent vehicle (e.g., adjacent location, speed, movement, and driving pattern) during learning is similar to the current state of the same type of vehicle as the adjacent vehicle.

Subsequently, as in the example 103 shown in FIG. 5, the learned autonomous driving artificial intelligence model 13 may output the driving pattern of the present vehicle 200. In detail, the present vehicle 200 may sense the same type of vehicle 204 as the adjacent vehicle of which driver shows a specific driving pattern. Afterwards, the learned autonomous driving artificial intelligence model 13 may output a driving pattern in which the present vehicle 200 changes a lane and overtakes the adjacent vehicle 204.

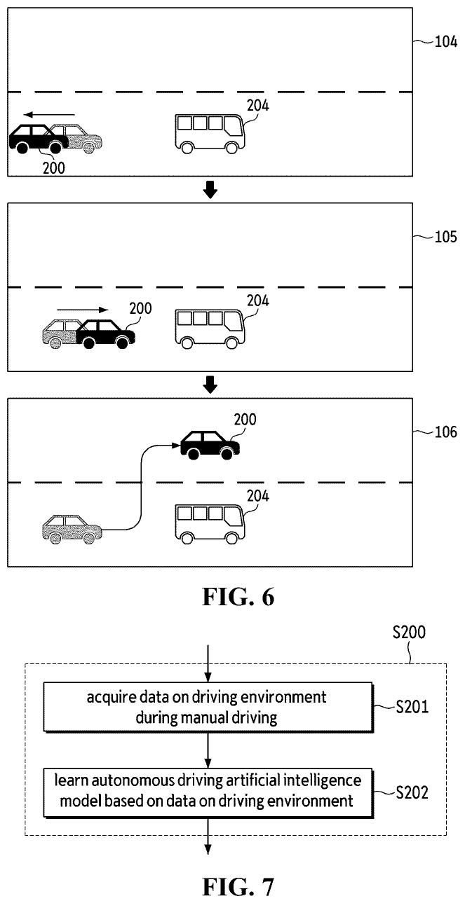

In this case, it should be noted that the output driving pattern is not limited to overtaking. For example, as in the example 104 shown in FIG. 6, when the present vehicle 200 is adjacent to the adjacent vehicle 204, the present vehicle 200 may decelerate to increase the vehicle-to-vehicle distance. As another example, as in the example 105 shown in FIG. 6, when the present vehicle 200 is adjacent to the adjacent vehicle 202, the present vehicle 204 may accelerate to reduce the vehicle-to-vehicle distance. As another example, as in the example 106 shown in FIG. 6, when the preset vehicle 200 is adjacent to the adjacent vehicle 204, the present vehicle 200 may change a lane so that the adjacent vehicle 202 is not visible in front of the present vehicle 200.

The output driving pattern is not limited to the above-described example, and when the present vehicle is adjacent to the adjacent vehicle, the output driving pattern may include all types of driving patterns seen by the present vehicle. However, it should be noted that driving patterns that cause an accident or threaten safety may be excluded.

The autonomous driving control method according to the present embodiment has been described with reference to FIGS. 2 to 6. According to the above-described autonomous driving control method, the driving pattern of the driver may be automatically identified and reflected in autonomous driving. Also, a personalized driving experience may be provided to the driver. In particular, driving convenience and satisfaction of the driver may be improved by reflecting acceleration, braking, lane change style, and the like, which are preferred by the driver.

Environmental conditions other than the adjacent vehicle may be additionally considered, and thus the driving pattern of the driver may be applied to autonomous driving in a more suitable situation. For example, since the driver tends to avoid a loaded vehicle such as a truck, there may be a driving pattern in which the driver avoids and overtakes the truck when encountering the truck. However, when all the drivers'view on the road is restricted due to severe rain or fog, overtaking the truck may threaten a safety, and may be different from the driver's driving style. Therefore, since an autonomous driving control method considering environmental factors related to driving is required, an embodiment considering environmental factors will be described below.

First, as shown in FIG. 7, when the adjacent vehicle is located within a preset distance from the present vehicle which is in manual driving, data on the driving environment may be acquired during the manipulation collection period (S201).

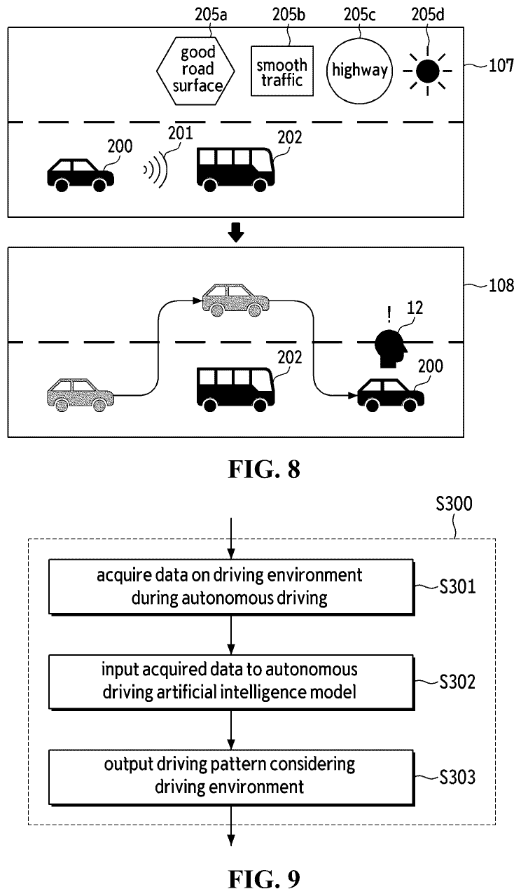

For example, as in the example 107 shown in FIG. 8, when the present vehicle 200 which is in manual driving senses (201) the adjacent vehicle 202, data 205a on road surface condition, data 205b on traffic congestion, data 205c on road type, and data 206c on weather condition during driving may be acquired. In detail, the current location of the present vehicle may be specified through GPS data, and data (e.g., road surface condition, traffic congestion, and road type) on the driving environment at a specific location may be transmitted from a database. In addition, data on the driving environment may be measured using a sensor included in the vehicle.

In addition, as in the example 108 shown in FIG. 8, data (e.g., detailed vehicle model of the adjacent vehicle, type of the adjacent vehicle, speed of the adjacent vehicle, and detailed movement of the adjacent vehicle) on the adjacent vehicle 202 and data (e.g., acceleration/deceleration, brake, steering, handling, whether to change lane, whether to overtake, whether to change vehicle-to-vehicle distance) on driving-related manipulation of the present vehicle 200 may be acquired together with the data on the driving environment.

Referring back to FIG. 7, the autonomous driving artificial intelligence model may be learned using the acquired data on the driving environment (S202). For example, the autonomous driving artificial intelligence model may be learned to receive adjacent vehicle data and driving environment data and output data on driving-related manipulation of the present vehicle. In the learning step, adjacent vehicle data, driving environment data, and data on driving-related manipulation of the present vehicle are input to the model together, and the output data on driving-related manipulation may be compared with data on actual driving-related manipulation, whereby loss may be calculated. The weight of the model may be repeatedly adjusted to minimize loss. When the learning is completed, only adjacent vehicle data and driving environment data may be input in the inference step, so that the data on driving-related manipulation of the present vehicle may be output. As a result, when information on the adjacent vehicle and information on the driving environment is input, a driving pattern expected to be seen by the driver of the present vehicle may be output. Hereinafter, it should be noted that when the driving pattern is output, it may be understood that data on driving-related manipulation may be output by inference.

Next, the operation in which actual autonomous driving is controlled after the learning process will be described.

First, as shown in FIG. 9, when the adjacent vehicle is sensed within a preset distance from the present vehicle that is in autonomous driving, data on the driving environment may be acquired (S301).

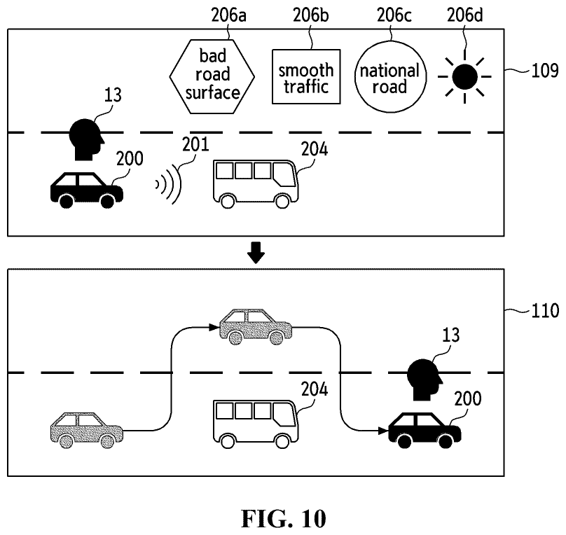

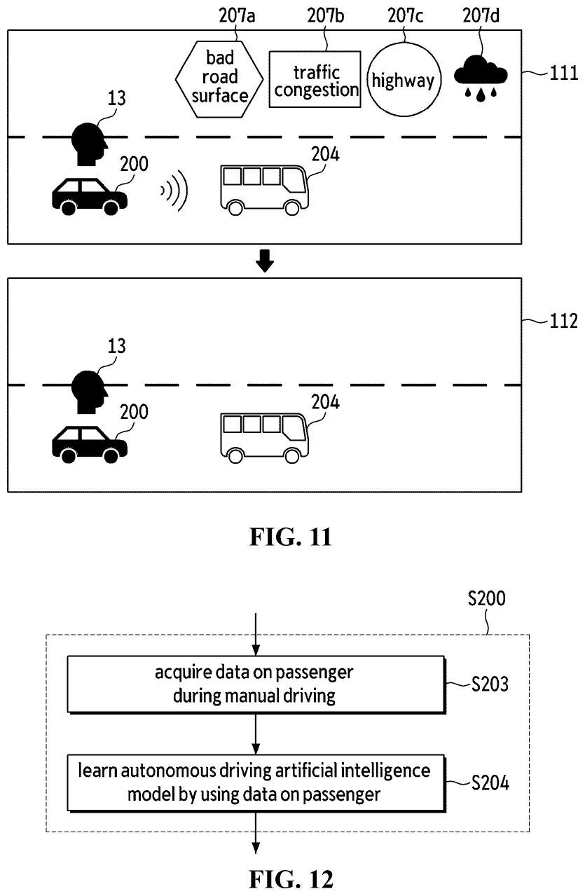

For example, as in the example 109 shown in FIG. 10 and the example 111 shown in FIG. 11, data on a driving environment at the time when the present vehicle 200 which is in autonomous driving senses (201) the adjacent vehicle 204 may be acquired. In this case, the data on the driving environment may include data on road surface conditions 206a and 207a, traffic congestion levels 206b and 207b, road types 206c and 207c, and weather conditions 206d and 207d at the time when the present vehicle 200 senses (201) the adjacent vehicle 204.

Referring back to FIG. 9, the data on the driving environment together with the data on the adjacent vehicle may be additionally input to the autonomous driving artificial intelligence model (S302). Subsequently, a driving pattern of the present vehicle considering a driving environment may be output using the input data (S303). As a result, when the adjacent vehicle is located within a preset distance from the present vehicle which is in autonomous driving, the driving pattern of the present vehicle may be output.

For example, as shown in FIG. 8, when the present vehicle 200, which is in manual driving, overtakes a bus that is the adjacent vehicle 202, the road surface condition 205a is ‘good road surface’, the traffic congestion level 205b is ‘smooth traffic’, the road type 205c is ‘highway’, and the weather condition 205d is ‘clear’. The autonomous driving artificial intelligence model 12 may output a driving pattern in which the present vehicle 200 overtakes the adjacent vehicle 202, in a driving environment similar to that at the time of learning.

As in the example 110 shown in FIG. 10, when the present vehicle 200 is in autonomous driving, the road surface condition 206a is ‘bad road surface’, the traffic congestion level 206b is ‘smooth traffic’, the road type 206c is ‘national road’, and the weather condition 206d is ‘clear’. The learned autonomous driving artificial intelligence model 13 has the same input driving environmental elements (e.g., traffic congestion, weather condition), and thus may output the same driving pattern (e.g., overtaking) as the driving pattern seen when the driver encounters the bus.

The number of the driving environment elements that should be matched in order to show the same driving pattern as the driver may vary depending on learning of the autonomous driving artificial intelligence model. It should be noted that the above-described example is for convenience of description, and it is not necessary for two or more driving environment elements to match, as in the above examples, to output the same driving pattern as the driver.

As another example, as in the example 112 shown in FIG. 11, when the present vehicle which is in manual driving overtakes a bus, the road surface condition 205a is ‘good road surface’, the traffic congestion level 205b is ‘smooth traffic’, the road type 205c is ‘highway’ and the weather condition 205d is ‘clear’. When the present vehicle is in autonomous driving, the road surface condition 207a is ‘bad road surface’, the traffic congestion level 207b is ‘traffic congestion’, the road type 207c is ‘highway’ and the weather condition 206d is ‘rain’. The learned autonomous driving artificial intelligence model 13 may output a driving pattern (e.g., maintaining a vehicle-to-vehicle distance) different from the driving pattern seen when the driver encounters the bus because most driving environment elements (e.g., road surface condition, traffic congestion, and weather condition) are inconsistent.

Afterwards, autonomous driving of the present vehicle may be controlled in accordance with the output driving pattern. In detail, a route of the present vehicle may be determined in accordance with the output driving pattern, and manipulation of a driving-related device (e.g., excel, brake, and handle) of the present vehicle may be controlled so as to drive on the determined route.

The conditions of the passenger are additionally considered, and thus the driving pattern of the driver may be applied to autonomous driving in a more suitable situation. For example, the driving pattern of the driver may vary depending on whether a passenger has an infant or a child. Therefore, since an autonomous driving control method considering the factors of the passenger is required, an embodiment in which the factors of the passenger are considered will be described below.

First, as shown in FIG. 12, when the adjacent vehicle is located within a preset distance from the present vehicle which is in manual driving, data on the passenger may be acquired during the manipulation collection period (S203).

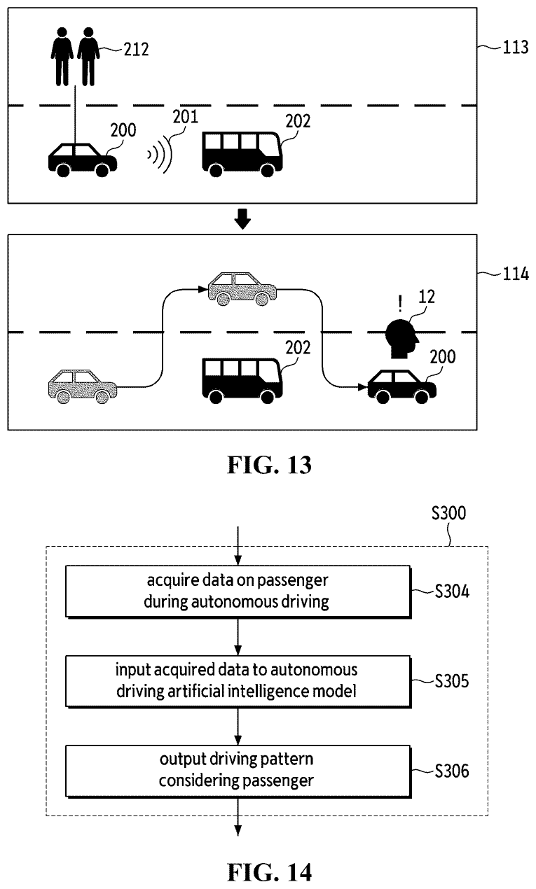

For example, as in the example 113 shown in FIG. 13, when the present vehicle 200 which is in manual driving senses (201) the adjacent vehicle 202, data 212 on the passenger may be acquired. The data 212 on the passenger may include data on the number of passengers, the type of passengers (e.g., adult, adolescent, infant, elderly, and companion animal), a combination of passengers, a location of the passenger in the vehicle, and a driver.

As a detailed example, a sensor capable of sensing weight may be embedded in the seat of the vehicle. It may be determined that passengers are on board as many as the number of sensors sensing the weight. That is, the number of passengers and the location of the passenger in the vehicle may be determined through the sensor that senses the weight. Also, a sensor capable of sensing an area touched by the passenger may be embedded in the seat of the vehicle. The type of passenger (e.g., adult, adolescent, infant, elderly, and companion animal) may be determined through the area touched by the passenger and the weight of the passenger. The combination of passengers may be determined through the determined type of passenger.

As a detailed example, the data on the driver may be acquired through an input of the driver. Before starting driving, the driver may select his or her profile on a computing device (e.g., navigator) provided in the vehicle and input that the current driver is himself or herself. In addition, the data on the driver may be inversely acquired through data on driving-related manipulation of the present vehicle. The driver may be identified using information on an average speed of the present vehicle, the number of times the driver brakes, the number of times the driver changes lanes, the type of vehicle that overtakes or avoids, and the like.

Referring back to FIG. 12, the autonomous driving artificial intelligence model may be learned using the acquired data on the passenger (S204). For example, the autonomous driving artificial intelligence model may be learned to receive adjacent vehicle data and the data on the passenger and output data on driving-related manipulation of the present vehicle. In the learning step, the adjacent vehicle data, the data on the passenger and the data on driving-related manipulation of the present vehicle are input to the model together, and the output data of the driving-related manipulation may be compared with data on actual driving-related manipulation, whereby loss may be calculated. The weight of the model may be repeatedly adjusted to minimize loss. When the learning is completed, only the adjacent vehicle data and the data on the passenger may be input in the inference step, so that the data on driving-related manipulation of the present vehicle may be output. As a result, the autonomous driving artificial intelligence model may learn contents such as “when the passenger is the driver alone, the driver of the present vehicle overtakes the bus at a high speed,” “when the passenger is the driver and the adult passenger, the driver of the present vehicle overtakes the bus at a normal speed,” and “when the passenger is the driver and the infant passenger, the driver of the present vehicle does not overtake the bus.”

Next, the operation in which actual autonomous driving is controlled after the learning process will be described.

First, as shown in FIG. 14, when the adjacent vehicle is sensed within a preset distance from the present vehicle which is in autonomous driving, the data on the passenger may be acquired (S301).

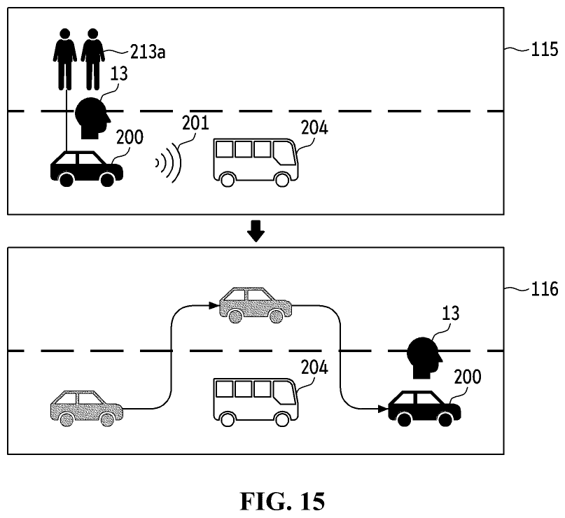

For example, as in the example 115 shown in FIG. 15, data 213a on the passenger at the time when the present vehicle 200 senses (201) the adjacent vehicle 204 may be acquired. In this case, the data 213a on the passenger may include information that there are two passengers and both of the passengers are adults.

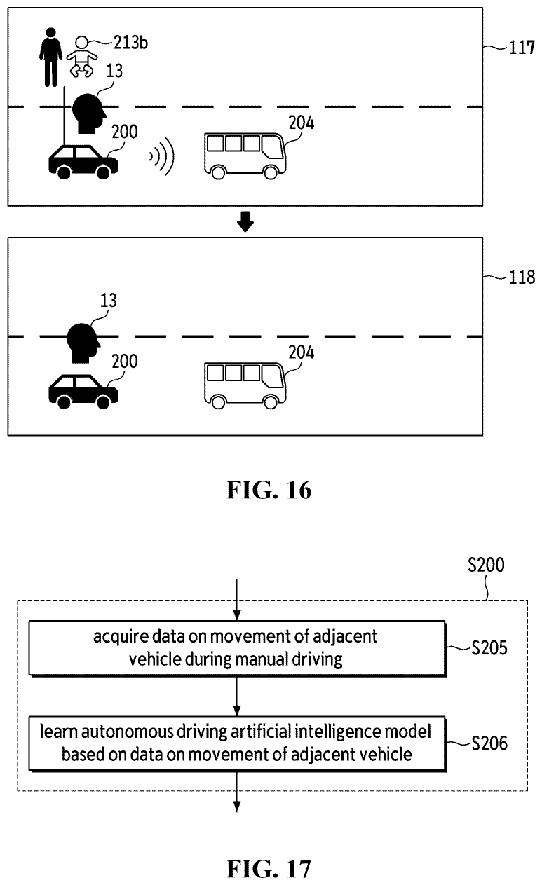

As another example, as in the example 117 shown in FIG. 16, data 213b on the passenger at the time when the present vehicle 200 senses (201) the adjacent vehicle 204 may be acquired. In this case, the data 213b on the passenger may include information that there are two passengers, one of the passengers is an adult, and the other passenger is an infant.

Referring back to FIG. 14, the data on the passenger acquired during autonomous driving may be additionally input to the autonomous driving artificial intelligence model together with the data on the adjacent vehicle (S305). Next, the output for the driving pattern considering the passenger may be output using the input data (S306). In this case, the driving pattern of the present vehicle may mean a driving pattern that simulates the driving pattern seen by the driver of the present vehicle when there is a current passenger and the present vehicle encounters the current adjacent vehicle.

For example, as shown in FIG. 13, when the present vehicle 200 that is in manual driving overtakes the bus 202, the number of passengers is two, and types of passengers are all adults. In this case, the autonomous driving artificial intelligence model 12 may output the same driving pattern (e.g., overtaking) as the driving pattern seen when the driver encounters the bus when the data on the passenger is similar to that at the time of learning.

As in the example 115 shown in FIG. 15, the number of passengers of the present vehicle 200 which is in autonomous driving is two, and types of passengers may be all adults. Since the data on the passenger is the same as that at the time of learning, the learned autonomous driving artificial intelligence model 13 may output the same driving pattern (e.g., overtaking) as the driving pattern seen when the driver encounters the bus.

For another example, as in the example 117 shown in FIG. 16, the number of passengers of the present vehicle 200 which is in autonomous driving is two, one passenger type may be an adult, and the other passenger type may be an infant. Since the data on the passenger is not similar to that at the time of learning, the learned autonomous driving artificial intelligence model 13 may output a driving pattern (e.g., maintaining a vehicle-to-vehicle distance) different from the driving pattern seen when the driver encounters the bus.

The conditions of movement of the adjacent vehicle are additionally considered, and thus the driving pattern of the driver may be applied to autonomous driving in a more suitable situation. For example, the driving pattern of the driver may vary in a case in which the truck rapidly approaches the vehicle of the driver and a case in which the truck is adjacent to or does not approach the vehicle of the driver. Therefore, since an autonomous driving control method considering the factors of the movement of the adjacent vehicle is required, an embodiment in which the factors of the movement of the adjacent vehicle are considered will be described below.

First, as shown in FIG. 17, when the adjacent vehicle is located within a preset distance from the present vehicle which is in manual driving, data on the movement of the adjacent vehicle may be acquired during the manipulation collection period (S205).

The data on the movement of the adjacent vehicle may include data on the speed of the adjacent vehicle, the direction in which the adjacent vehicle moves, the distance between the adjacent vehicle and the present vehicle, data as to whether the adjacent vehicle changes a lane, and data on the relative location change of the adjacent vehicle based on the present vehicle.

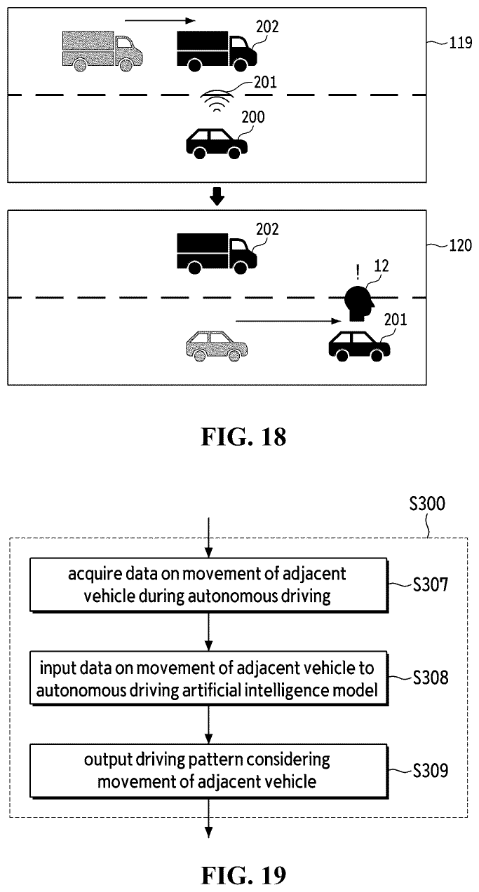

For example, as in the example 119 shown in FIG. 18, when the present vehicle 200 which is in manual driving senses (201) the adjacent vehicle 202, the data on the relative location change of the adjacent vehicle 202 and the data on the speed of the adjacent vehicle 202 may be acquired. In detail, the direction in which the adjacent vehicle 202 is located based on the present vehicle may be sensed through the image sensor or the lidar. In addition, it is possible to sense how the location of the adjacent vehicle 202 has changed within a preset time from the time when the adjacent vehicle 202 has been sensed (201). The adjacent vehicle 202 of the example 119 is located behind the left side of the present vehicle 200. In addition, the adjacent vehicle 202 of the example 119 has moved to the left side of the present vehicle 200 during the preset period. The data on the movement of the adjacent vehicle may be generated through the relative location change of the adjacent vehicle 202. In this case, the data on the movement of the adjacent vehicle may include content on “an adjacent vehicle moving from the left rear to the left side.”

Referring back to FIG. 17, the autonomous driving artificial intelligence model may be learned using the acquired data on the movement of the adjacent vehicle (S206). For example, the autonomous driving artificial intelligence model may be learned to receive the data on the type of the adjacent vehicle and the data on the movement of the adjacent vehicle and output the data on driving-related manipulation of the present vehicle. In the learning step, the data on the type of the adjacent vehicle, the data on the movement of the adjacent vehicle and the data on driving-related manipulation of the present vehicle are input to the model together, and the output data may be compared with data on actual driving-related manipulation, whereby loss may be calculated. The weight of the model may be repeatedly adjusted to minimize loss. When the learning is completed, only the data on the type of the adjacent vehicle and the data on the movement of the adjacent vehicle may be input in the inference step, so that the data on driving-related manipulation of the present vehicle may be output.

As a result, even though the same type of adjacent vehicle (e.g., bus) is sensed, the autonomous driving artificial intelligence model may output a different driving pattern (e.g., increasing vehicle-to-vehicle distance by acceleration, maintaining speed, changing lanes) when the movement of the adjacent vehicle (e.g., driving while maintaining vehicle-to-vehicle distance, driving while narrowing vehicle-to-vehicle distance, and overtaking) is different.

Next, the operation in which actual autonomous driving is controlled after the learning process will be described.

First, as shown in FIG. 19, when the adjacent vehicle is sensed within a preset distance from the present vehicle which is in autonomous driving, the data on the movement of the adjacent vehicle may be acquired (S307).

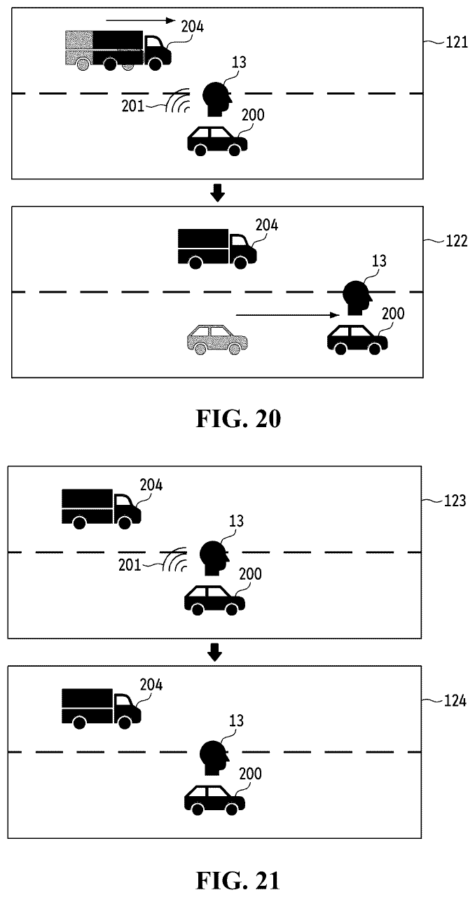

For example, as in the example 121 shown in FIG. 20 and the example 123 shown in FIG. 21, data on the movement of the adjacent vehicle 204 at the time when the present vehicle 200 senses (201) the adjacent vehicle 204 may be acquired. In this case, the data on the movement of the adjacent vehicle may include the speed of the adjacent vehicle, whether the adjacent vehicle changes a lane, the distance between the adjacent vehicle and the present vehicle, and the location (e.g., front, rear, and side) at which the adjacent vehicle is adjacent to the present vehicle.

In detail, as in the example 121 shown in FIG. 20, it may be sensed that the adjacent vehicle 204 is accelerated to move from the left rear to the left side. On the contrary, as in the example 123 shown in FIG. 20, it may be sensed that the adjacent vehicle 204 is continuously located at the left rear without acceleration.

Referring back to FIG. 19, the data on the movement of the adjacent vehicle together with data on the type of the adjacent vehicle may be additionally input to the autonomous driving artificial intelligence model (S308). Subsequently, the driving pattern of the present vehicle, in which the movement of the adjacent vehicle is considered, may be output using the input data.

For example, as shown in FIG. 18, the present vehicle 200 which is in manual driving may avoid a truck that is an approaching adjacent vehicle 202. When the present vehicle 200 avoids the adjacent vehicle, an original location of the adjacent vehicle may be ‘left rear’, a relative location change of the adjacent vehicle may be ‘movement from left rear to left side’, and a speed of the adjacent vehicle may be ‘120 km/h’. The autonomous driving artificial intelligence model 12 may learn a situation as in the above-described example and output the driving pattern of the present vehicle 200 with respect to the adjacent vehicle showing a movement similar to the above-described example.

As in the example 121 shown in FIG. 20, when the present vehicle 200 is in autonomous driving, the original location of the adjacent vehicle is ‘left rear’, the relative location change of the adjacent vehicle is ‘movement from left rear to left side’, and the speed of the adjacent vehicle is ‘110 km/h’. In this case, since most of the input data on the movement of the adjacent vehicle is similar to that at the time of learning, the learned autonomous driving artificial intelligence model 13 may output the same driving pattern (e.g., avoiding forward by acceleration) as the driving pattern of the driver of the present vehicle, which is seen when the truck approaches the present vehicle 200.

For another example, as in the example 123 shown in FIG. 21, when the present vehicle 200 is in autonomous driving, the original location of the adjacent vehicle is ‘left rear’, the relative location change of the adjacent vehicle is ‘none’, and the speed of the adjacent vehicle is ‘100 km/h’. In this case, since most of the input data on the movement of the adjacent vehicle is not similar to that at the time of learning, the learned autonomous driving artificial intelligence model 13 may output a driving pattern (e.g., maintaining speed) different from the driving pattern seen by the driver of the present vehicle 200 when a truck approaches.

Afterwards, autonomous driving of the present vehicle may be controlled in accordance with the output driving pattern. In detail, an expected route of the present vehicle may be determined in accordance with the output driving pattern, and manipulation of a driving-related device (e.g., excel, brake, and handle) of the present vehicle may be controlled to drive on the determined expected route.

Among the driving patterns of the driver, there may be a driving pattern that is inappropriate for autonomous driving artificial intelligence to output. For example, when autonomous driving of the present vehicle is controlled in accordance with a driving pattern causing an accident or having a high probability of causing an accident, the accident may occur. Accordingly, an embodiment in which an exceptional situation excluded from the learning of the autonomous driving artificial intelligence model is set will be described.

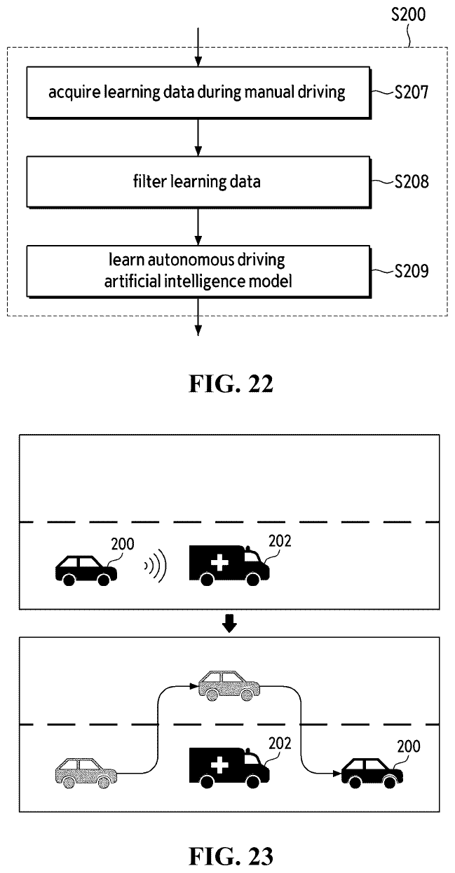

First, as shown in FIG. 22, when the adjacent vehicle is located within a preset distance from the present vehicle which is in manual driving, the learning data may be acquired (S207). In this case, the learning data may include the data on the type of the adjacent vehicle, the data on the movement of the adjacent vehicle, the data on the driving environment, and the data on the passenger, which are described in the above-described embodiment.

Subsequently, filtering may be performed for the acquired learning data (S208). In this case, filtering the learning data may mean removing data that is output by the autonomous driving artificial intelligence model and inappropriate for controlling autonomous driving or has noise. A criterion for filtering may be arbitrarily set.

For example, a criterion for filtering may be arbitrarily set, such as “filtering a driving pattern that overtakes an emergency vehicle (e.g., a fire engine, an emergency vehicle, and a police vehicle). Subsequently, as shown in FIG. 23, the present vehicle 200 may sense the adjacent vehicle 202 that is an emergency vehicle. Afterwards, the present vehicle 200 may overtake the adjacent vehicle 202 that is an emergency vehicle. In this case, the learning data acquired in a process in which the present vehicle 200 overtakes the adjacent vehicle 202, which is an emergency vehicle, may be excluded from a dataset for learning the autonomous driving artificial intelligence model. Also, even though the learning data is not excluded from the dataset, the weight may be adjusted so that the above-described driving pattern is not output.

In addition, the criterion for filtering may be set using a case in which an accident occurs or an accident is likely to occur during the manipulation collection period.

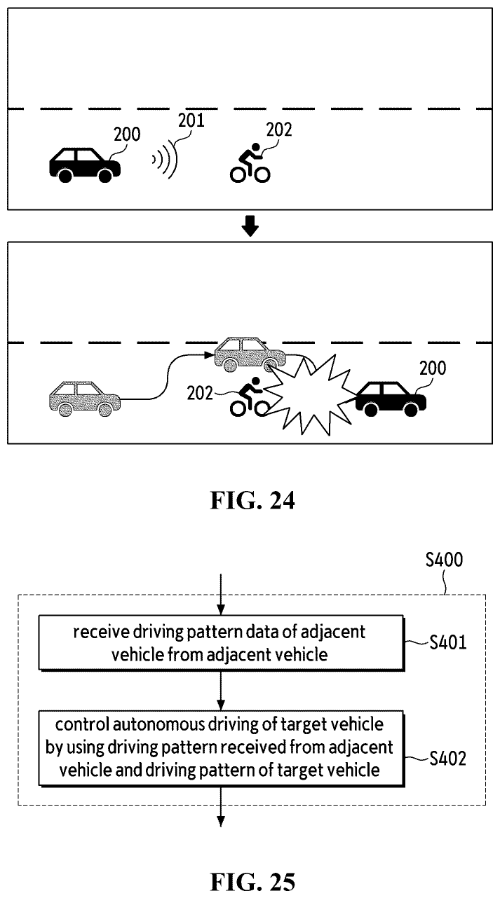

For example, as shown in FIG. 24, the present vehicle 200 may sense (201) the adjacent vehicle 202 that is a bicycle. Afterwards, the present vehicle 200 may overtake the adjacent vehicle 202. After overtaking, an accident may occur because a distance between the present vehicle 200 and the adjacent vehicle 202 is very short. When an accident occurs, learning data acquired in a process in which the present vehicle 200 overtakes the adjacent vehicle 202 that is a bicycle may be excluded from the dataset for learning the autonomous driving artificial intelligence model. In addition, even though the learning data is not excluded from the dataset, the weight may be adjusted so that the above-described driving pattern is not output.

When the adjacent vehicle is also a vehicle that is in autonomous driving, both the driving pattern of the present vehicle and the driving pattern of the adjacent vehicle may be acquired through communication between the present vehicle and the adjacent vehicle. Autonomous driving of the present vehicle may be more efficiently controlled using all the acquired driving patterns. Hereinafter, an embodiment in which V2V communication is used will be described.

First, as shown in FIG. 25, the driving pattern of the adjacent vehicle may be received from the adjacent vehicle (S400). In this case, the driving pattern of the adjacent vehicle may mean an expected route of the adjacent vehicle that is in autonomous driving and a detailed movement (e.g., speed, acceleration, handling, whether to change lane, or whether to overtake) of the adjacent vehicle for driving on the expected route.

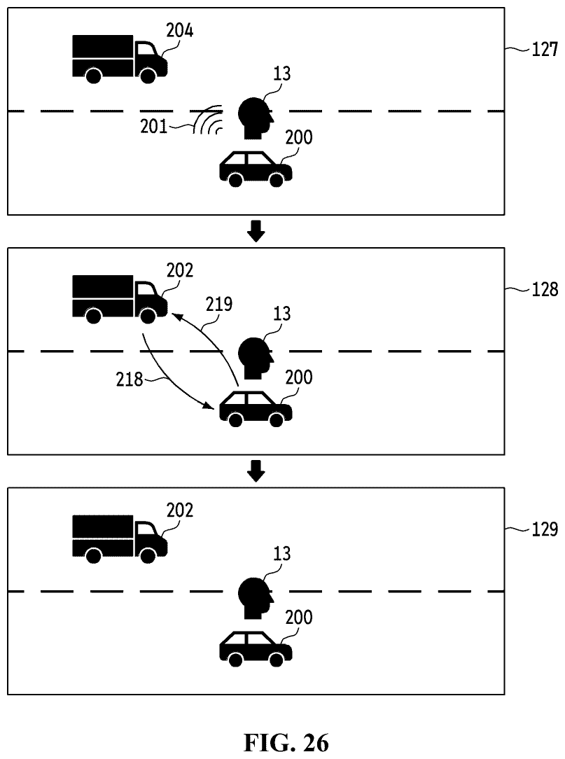

For example, as in the example 127 shown in FIG. 26, the present vehicle 200 may sense (201) that the adjacent vehicle 204 approaches the side of the present vehicle 200. Subsequently, as in the example 128, the present vehicle 200 may receive driving pattern data of the adjacent vehicle 204 from the adjacent vehicle 204. In addition, the present vehicle 200 may transmit driving pattern data of the present vehicle 200 to the adjacent vehicle 204.

In detail, the driving pattern data of the present vehicle 200 may include the content “when the truck at the rear is to move to the side of the present vehicle, the present vehicle accelerates to avoid the truck.” In addition, the driving pattern data of the adjacent vehicle 204 may include the content “when a passenger car is located at the front, the speed is maintained to maintain the vehicle-to-vehicle distance.”

Referring back to FIG. 25, autonomous driving of the present vehicle may be controlled using data on the driving pattern received from the adjacent vehicle and data on the driving pattern of the present vehicle (S402).

For example, an expected route of the adjacent vehicle may be output using the driving pattern data received from the adjacent vehicle, and an expected route of the present vehicle may be output using the driving pattern data of the present vehicle. Also, a detailed movement of the adjacent vehicle may be output using the driving pattern data of the adjacent vehicle, and a detailed movement of the present vehicle may be output using the driving pattern data of the present vehicle. The output route may be compared with the detailed movement, so that a new expected route of the present vehicle, in which two vehicles collide or do not move rapidly, may be determined.

As a detailed example, as shown in FIG. 26, according to the driving pattern of the present vehicle 200, since the present vehicle 200 senses the adjacent vehicle 204 at the rear, the present vehicle 200 may accelerate and move forward before the adjacent vehicle 204 comes to the side. However, according to the driving pattern of the adjacent vehicle 204, the adjacent vehicle 204 may maintain a current relative location without moving to the side of the present vehicle 200. Accordingly, the present vehicle 200 may drive while maintaining a distance from the adjacent vehicle 204 without accelerating and moving forward.

That is, the route of the present vehicle may be adjusted using the data on the route of the adjacent vehicle, which is received from the adjacent vehicle. In this case, adjusting the route of the present vehicle may include modifying the route of the present vehicle so that the route of the adjacent vehicle and the route of the present vehicle do not overlap each other, or modifying the route of the present vehicle from a route avoiding the adjacent vehicle to a route that drives as it is because the adjacent vehicle does not approach.

The conditions of the driver's voice are additionally considered, and thus the driving pattern of the driver may be applied to autonomous driving in a more suitable situation. For example, the driver's voice may vary depending on the driver's stress level. When the driver's stress level is high, the accent and volume of the driver's voice may be louder, and the likelihood of the driver's voice including slang may increase. Also, when the driver's stress level is high, the driver may drive faster, change lanes more and overtake more vehicles. Therefore, since an autonomous driving control method considering the factors for the driver's voice is required, an embodiment in which the factors for the driver's voice of the adjacent vehicle are considered will be described below.

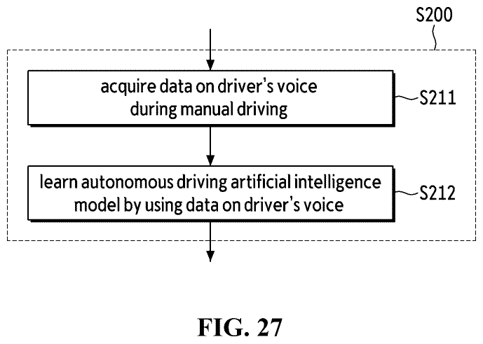

First, as shown in FIG. 27, when the adjacent vehicle is located within a preset distance from the present vehicle which is in manual driving, data on the driver's voice may be acquired during the manipulation collection period (S211).

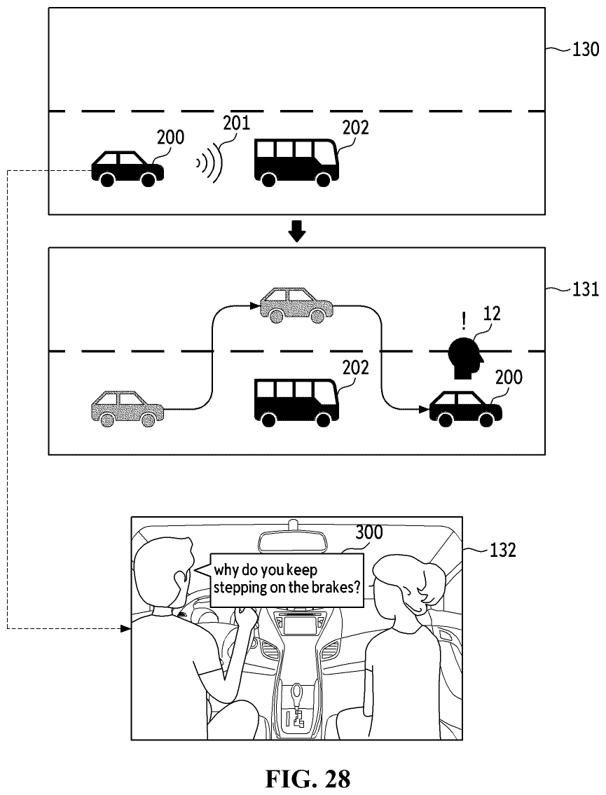

For example, as shown in FIG. 28, when the present vehicle 200 which is in manual driving senses (201) the adjacent vehicle 202, the driver's voice 300 may be sensed. The data on the driver's voice may include a voice pitch (e.g., high pitch), a voice size (e.g., high volume), and keywords (e.g., no, why, brake, step) included in the voice.

Subsequently, the autonomous driving artificial intelligence model may be learned using the acquired data on the driver's voice (S202). For example, after the driver's voice signal is collected, features (e.g., voice size, voice pitch change, and keywords included in the voice) may be extracted from the driver's voice. At the same time, data (e.g., acceleration, deceleration, steering, handling, whether to change lane, and whether to overtake) for the driving-related manipulation of the present vehicle may be collected, and a stress level or an emotional state may be assigned to the data on the driver's voice and the data on driving-related manipulation as a label. Afterwards, the autonomous driving artificial intelligence model may be learned through supervised learning by using the label as a correct answer. The autonomous driving artificial intelligence model may learn the correlation between the features of the driver's voice and the driving pattern of the present vehicle.

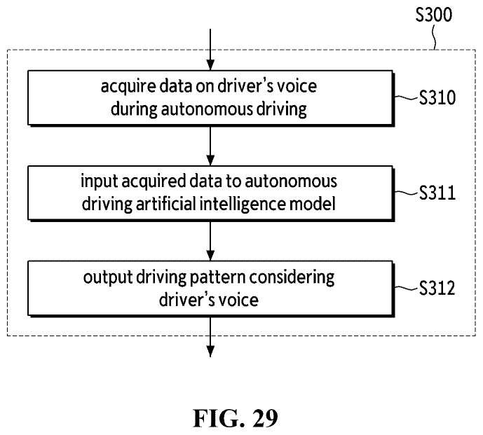

Next, as shown in FIG. 29, when the adjacent vehicle is sensed within a preset distance from the present vehicle which is in autonomous driving, the data on the driver's voice may be acquired (S310).

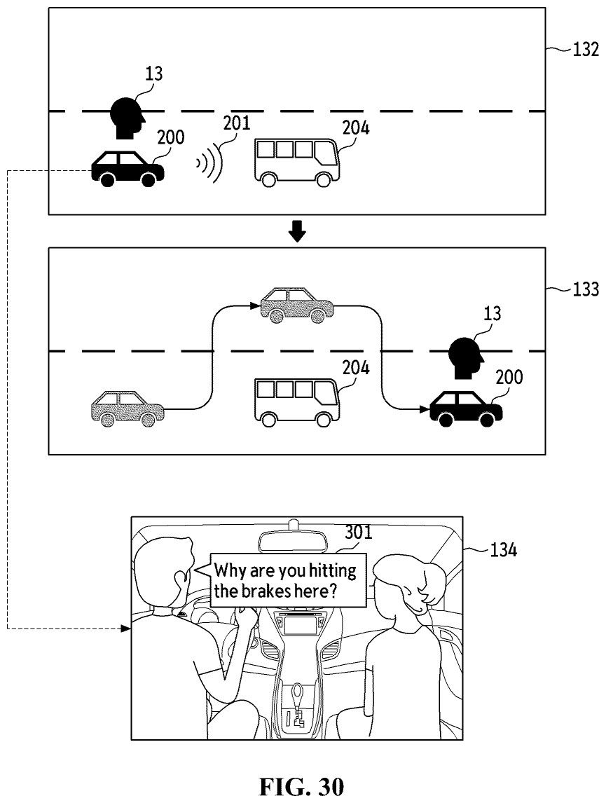

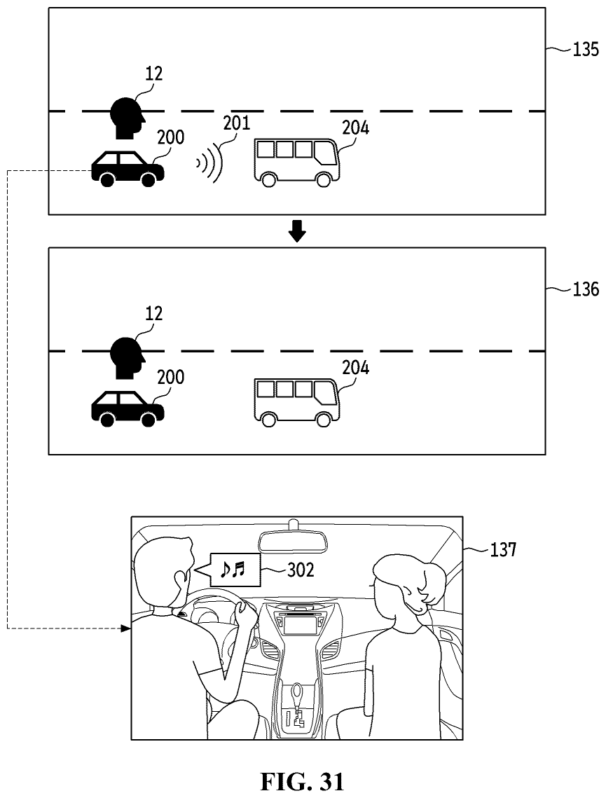

For example, as in the example 134 shown in FIG. 30 and the example 135 shown in FIG. 31, when the adjacent vehicle 204 is located within a preset distance from the present vehicle 200 which is in autonomous driving, the data on the driver's voice may be acquired.

Referring back to FIG. 29, the data on the driver's voice may be additionally input to the autonomous driving artificial intelligence model (S311) together with the data on the adjacent vehicle. Subsequently, the driving pattern of the present vehicle considering the driver's voice may be output using the input data (S312).

For example, as shown in FIG. 30, the data on the driver's voice 301 may be input to the learned autonomous driving artificial intelligence model 13. In this case, the data on the driver's voice 301 may include information on a voice volume (e.g., large volume), a voice pitch (e.g., high voice), and voice keywords (e.g., why, brake, and step). The learned autonomous driving artificial intelligence model 13 may determine that the input data on the driver's voice 301 is similar to the data on the driver's voice 300 when the present vehicle overtakes the adjacent vehicle at the time of learning. Subsequently, the learned autonomous driving artificial intelligence model 13 may output the driving pattern of the present vehicle 200 that overtakes the adjacent vehicle 204, as at the time of learning.

For another example, as shown in FIG. 31, the data on the driver's voice 302 may be input to the learned autonomous driving artificial intelligence model 13. In this case, the data on the driver's voice 301 may include information on a voice volume (e.g., a normal volume), a voice pitch (e.g., a flat voice), and a voice keyword (e.g., a song). The autonomous driving artificial intelligence model 12 may determine that the input data on the driver's voice 302 is not similar to the data on the driver's voice 300 when the present vehicle overtakes the adjacent vehicle at the time of learning. Subsequently, the learned autonomous driving artificial intelligence model 13 may output the driving pattern of the present vehicle 200 that does not overtake the adjacent vehicle 204, unlike at the time of learning.

The method for learning an autonomous driving artificial intelligence model with learning data acquired in the driving process of one present vehicle and controlling autonomous driving of the present vehicle by using the learned autonomous driving artificial intelligence model has been described as above with reference to FIGS. 2 to 31.

In the above-described embodiment, one learning situation is presented, and the same driving pattern as the driver's driving pattern is output in a situation similar to the presented learning situation. However, the above-described embodiment is for convenience of description, and the learning situation may be not only one learning situation but also a plurality of learning situations. That is, in “the driver may show a specific driving pattern in a specific situation”, the specific situation may be a situation determined through a plurality of learning situations. For example, the driver may have 7 histories of not overtaking the bus at the front when it rains, and the driver may have 3 histories of overtaking the bus at the front when it rains. In this case, the autonomous driving artificial intelligence model may learn that the driver overtakes the bus when it rains, through learning.

Furthermore, in the above-described embodiment, the data (e.g., the data on the driving environment, the data on the movement of the adjacent vehicle, the data on the passenger, and the data on the driver's voice) learned together with the data on driving-related manipulation may be simultaneously used for learning. Also, the data (e.g., the data on the driving environment, the data on the movement of the adjacent vehicle, the data on the passenger, and the data on the driver's voice) acquired when controlling autonomous driving may be simultaneously acquired and input to the artificial intelligence model.

For example, the data on driving-related manipulation of the present vehicle, the data on the type and movement of the adjacent vehicle, the data on the driving environment, and the data on the driver's voice may all be used simultaneously for learning the autonomous driving artificial intelligence model. In addition, the data on driving-related manipulation of the present vehicle, the data on the type and movement of the adjacent vehicle, the data on the driving environment, and the data on the driver's voice may all be used simultaneously for controlling autonomous driving.

In one embodiment, the present vehicle in which the learning data is acquired may not be a single vehicle but be a plurality of vehicles. In this case, the plurality of vehicles may be a plurality of vehicles in which the same driver drives.

For example, first learning data for the autonomous driving artificial intelligence model may be acquired while the driver is manually driving a first vehicle. Subsequently, second learning data for the autonomous driving artificial intelligence model may be acquired while the driver is manually driving a second vehicle. The autonomous driving artificial intelligence model may be learned using the acquired first learning data and second learning data. Also, autonomous driving of the first vehicle or the second vehicle may be controlled by the learned autonomous driving artificial intelligence model.

In one embodiment, the present vehicle in which learning data is acquired and the present vehicle for autonomous driving control may be different from each other. In this case, both vehicles may be occupied by the same driver. When the present vehicle in which learning data is acquired and the present vehicle for autonomous driving control are different from each other, an operation in which the autonomous driving artificial intelligence model is applied to the present vehicle for autonomous driving control may be added before autonomous driving is controlled.

For example, learning data for the autonomous driving artificial intelligence model may be acquired while the driver is manually driving the first vehicle. Subsequently, the autonomous driving artificial intelligence model may be learned using the acquired learning data. Subsequently, the autonomous driving artificial intelligence model learned to control autonomous driving of the second vehicle different from the first vehicle may be applied to the second vehicle. In this case, the application of the learned autonomous driving artificial intelligence model to the second vehicle may mean checking a difference (e.g., the size of the vehicle body, the highest/average speed of the vehicle, the acceleration of the vehicle, and the time required for the vehicle to change lanes) between the first vehicle and the second vehicle, and correcting the difference so that the vehicle may simulate the same driving pattern. Subsequently, autonomous driving of the second vehicle may be controlled by the learned autonomous driving artificial intelligence model. In this case, the second vehicle may be a vehicle different from the first vehicle. Also, the second vehicle may be a vehicle in which the driver of the first vehicle rides.

In one embodiment, a computing device on which an autonomous driving artificial intelligence model that is being learned is mounted and a computing device on which a learned autonomous driving artificial intelligence model is mounted may be different from each other.

For example, the autonomous driving artificial intelligence model that is being learned may be mounted on a server. In addition, the learned autonomous driving artificial intelligence model may be mounted on a computing device embedded in a vehicle. In addition, the autonomous driving artificial intelligence model mounted on a computing device embedded in a vehicle may be an autonomous driving artificial intelligence model of a first version. In addition, the autonomous driving artificial intelligence model mounted on the server may be an autonomous driving artificial intelligence model of a second version. In this case, after the learning of the autonomous driving artificial intelligence model of the second version is completed, the autonomous driving artificial intelligence model mounted on the computing device embedded in the vehicle may be updated from the first version to the second version.

The effects according to the technical spirits of the present disclosure are not limited to those mentioned above, and other effects not mentioned will be clearly understood by those skilled in the art from the content of the present disclosure.

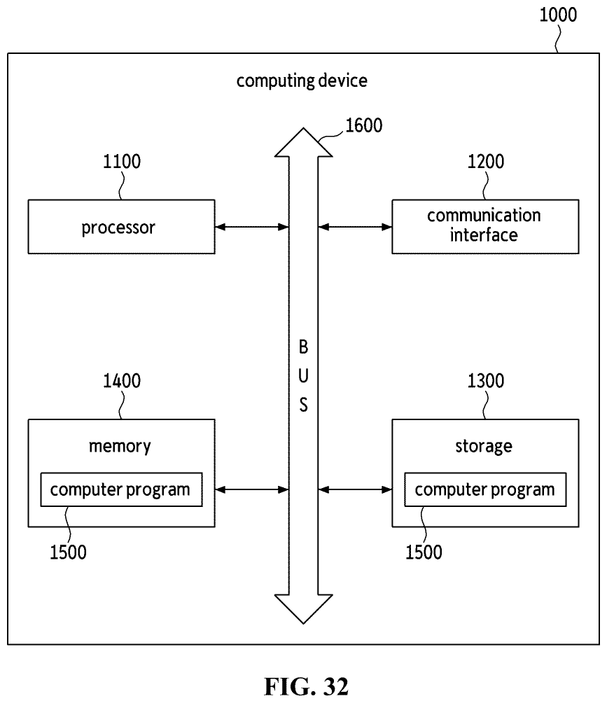

Hereinafter, a hardware configuration of an exemplary computing device according to some embodiments of the present disclosure will be described with reference to FIG. 32. The computing device may be a computing device on which the autonomous driving control apparatus of the present disclosure is driven.

FIG. 32 is a block diagram illustrating a hardware configuration of a computing device used in some embodiments of the present disclosure. A computing device 1000 according to the present embodiment may include one or more processors 1100, a system bus 1600, a communication interface 1200, a memory 1400 for loading the computer program 1500 performed by the processor 1100, and a storage 1300 for storing the computer program 1500. In FIG. 32, only components related to embodiments of the present disclosure are shown. Accordingly, it will be apparent to those skilled in the art to which the present disclosure pertains that the computing device may further include other general-purpose components in addition to the components shown in FIG. 32.

What is claimed is:

1. A method for controlling autonomous driving, which is performed by a computing device provided in a first mobility enabling autonomous driving, the method comprising:
acquiring data on driving-related manipulation of the first mobility during a manipulation collection period determined by an adjacent state maintenance period between the first mobility and a second mobility which are in manual driving; and
training an autonomous driving artificial intelligence model by using the data,
wherein the autonomous driving artificial intelligence model outputs a route of the first mobility when the first mobility which is in autonomous driving senses a third mobility adjacent thereto.

2. The method of claim 1, wherein the autonomous driving artificial intelligence model additionally outputs a manipulation value of a driving-related device of the first mobility to drive on the route when the first mobility which is in autonomous driving senses the third mobility adjacent thereto.

3. The method of claim 1, wherein the acquiring of the data on driving-related manipulation of the first mobility includes additionally acquiring environmental data on a driving environment of the first mobility during the manipulation collection period, and wherein the training of the autonomous driving artificial intelligence model includes training the autonomous driving artificial intelligence model by using the data on driving-related manipulation of the first mobility and the environmental data on the driving environment of the first mobility.

4. The method of claim 1, wherein the acquiring of the data on driving-related manipulation of the first mobility includes additionally acquiring passenger data on a passenger of the first mobility during the manipulation collection period, and wherein the training of the autonomous driving artificial intelligence model includes training the autonomous driving artificial intelligence model by using the data on driving-related manipulation of the first mobility and the passenger data on the passenger of the first mobility.

5. The method of claim 4, wherein the passenger data on the passenger includes data on a type of the passenger of the first mobility or a location of the passenger of the first mobility.

6. The method of claim 1, wherein the acquiring data on driving-related manipulation of the first mobility includes additionally acquiring type data on a type of the second mobility during the manipulation collection period, wherein the training the autonomous driving artificial intelligence model includes training the autonomous driving artificial intelligence model by using the data on driving-related manipulation of the first mobility and the type data on the type of the second mobility.

7. The method of claim 1, wherein the acquiring data on driving-related manipulation of the first mobility includes additionally acquiring location data on a relative location change of the second mobility during the manipulation collection period, and wherein the training the autonomous driving artificial intelligence model includes training the autonomous driving artificial intelligence model by using the data on driving-related manipulation of the first mobility and the location data on the relative location change of the second mobility.

8. The method of claim 1, wherein the acquiring data on driving-related manipulation of the first mobility includes additionally acquiring voice data on a driver's voice of the first mobility during the manipulation collection period, and wherein the training of the autonomous driving artificial intelligence model includes training the autonomous driving artificial intelligence model by using the data on driving-related manipulation of the first mobility and the voice data on the driver's voice of the first mobility.

9. The method of claim 8, wherein the voice data on the driver's voice includes data of a size of the driver's voice, a pitch of the driver's voice, or a keyword included in the driver's voice.

10. The method of claim 1, wherein the training of the autonomous driving artificial intelligence model by using the data further includes filtering the data based on whether a traffic accident has occurred during the manipulation collection period.

11. The method of claim 1, further comprising:
sensing the third mobility adjacent to the first mobility during the autonomous driving of the first mobility; and
controlling the autonomous driving of the first mobility so that the first mobility drives on the route output by the autonomous driving artificial intelligence model.

12. The method of claim 11, wherein the controlling of the autonomous driving of the first mobility includes:
receiving data on a route of the third mobility from the third mobility;
adjusting the route of the first mobility based on the route of the third mobility to generate an adjusted route; and
controlling the autonomous driving of the first mobility so that the first mobility drives on the adjusted route.

13. The method of claim 11, wherein the third mobility is a same type of mobility as the second mobility.

14. The method of claim 1, further comprising:
applying the autonomous driving artificial intelligence model to a fourth mobility;
sensing the third mobility adjacent to the fourth mobility during autonomous driving of the fourth mobility; and
controlling autonomous driving of the fourth mobility so that the fourth mobility drives on a route output by the autonomous driving artificial intelligence model,
wherein the fourth mobility is different from the first mobility.

15. The method of claim 14, wherein the fourth mobility is a mobility occupied by a driver of the first mobility.

16. An apparatus for controlling autonomous driving, the apparatus comprising:
a communication interface;
a memory in which a computer program is loaded; and
at least one processor in which the computer program is executed,
wherein the computer program includes a set of instructions to perform:
an operation of acquiring data on driving-related manipulation of a first mobility during a manipulation collection period determined determined by an adjacent state maintenance period between the first mobility and a second mobility which are in manual driving; and
an operation of training an autonomous driving artificial intelligence model by using the data,
wherein the autonomous driving artificial intelligence model outputs a route of the first mobility when the first mobility which is in autonomous driving senses a third mobility adjacent thereto.

17. The apparatus of claim 16, wherein the autonomous driving artificial intelligence model additionally outputs a manipulation value of a driving-related device of the first mobility to drive on the route when the first mobility which is in autonomous driving senses the third mobility adjacent thereto.

18. The apparatus of claim 16, wherein the computer program further includes instructions to perform:
an operation of sensing the third mobility adjacent to the first mobility during the autonomous driving of the first mobility; and
an operation of controlling the autonomous driving of the first mobility so that the first mobility drives on the route output by the autonomous driving artificial intelligence model.

19. The apparatus of claim 18, wherein the operation of controlling autonomous driving of the first mobility includes:
an operation of receiving data on a route of the third mobility from the third mobility;
an operation of adjusting the route of the first mobility based on the route of the third mobility to generate an adjusted route; and
an operation of controlling autonomous driving of the first mobility so that the first mobility drives on the adjusted route.

20. The apparatus of claim 16, wherein the computer program further includes instructions to perform:
an operation of applying the learned autonomous driving artificial intelligence model to a fourth mobility;
an operation of sensing the third mobility adjacent to the fourth mobility during autonomous driving of the fourth mobility; and
an operation of controlling autonomous driving of the fourth mobility so that the fourth mobility drives on a route output by the autonomous driving artificial intelligence model,
wherein the fourth mobility is different from the first mobility.
